(19) United States
(12) Patent Application Publication
(10) Pub. No.: US 2011/0018838 A1
(43) Pub. Date: Jan. 27, 2011

(54) Capacitive Type Touch Panel

(75) Inventor: Chih Yen Lee, Hsinchu County (TW)

Correspondence Address: WPAT, PC;INTELLECTUAL PROPERTY ATTORNEYS, 2030 MAIN STREET, SUITE 1300, IRVINE, CA, 92614, US

(73) Assignee: RITDISPLAY CORPORATION, Hsin Chu Industrial Park (TW)

(21) Appl. No.: 12/835,262

(22) Filed: Jul. 13, 2010

(30) Foreign Application Priority Data
Jul. 22, 2009 (TW) 098124672

(51) Int. Cl. G06F 3/045

(52) U.S. Cl. 345/174

(57) ABSTRACT

A capacitive type touch panel comprises a transparent substrate, a transparent conductive layer, an insulating layer, and a plurality of first leads. The transparent conductive layer is overlaid on a surface of the transparent substrate and comprises a plurality of first electrodes, a plurality of second electrodes and a plurality of connecting lines. The plurality of first electrodes and the plurality of second electrodes are arranged in a staggered manner, and the plurality of connecting lines respectively connect two adjacent second electrodes. The insulating layer comprises a plurality of insulating areas, wherein the plurality of insulating areas are respectively overlaid on the plurality of connecting lines. The plurality of first leads are respectively disposed on the plurality of insulating areas and respectively connect two adjacent first electrodes. Each of the first electrodes and second electrodes has a pattern which is formed by transparent electrode leads.

### BACKGROUND OF THE INVENTION

1. Field of the Invention

The present invention relates to a light transmission touch panel, and more particularly, to a touch panel having capacitance circuits.

2. Description of the Related Art

Touch panels have been widely applied in the fields of household appliances, communications, and electronic information devices. Common applications of the touch panel include input interfaces of personal digital assistants (PDA), electrical appliances, game machines, and other devices.

The current trend of integration of touch panel and display panel allows a user to use his or her finger or a stylus to indicate a control icon shown on the panel in order to execute a desired function on the device. The touch panel is also applied in public information inquiry systems to provide an is efficient operation system for the public.

A conventional touch panel comprises a transparent substrate having a surface on which sensing zones are distributed for sensing a signal associated with the touch of a user's finger or stylus to effect input and control. The sensing zones are made of transparent conductive membranes, such as indium tin oxide (ITO), and a user may touch the transparent conductive membrane corresponding to a specific location shown on the display to effect operation of the device.

In order to detect the location where a finger or a stylus touches the touch panel, a variety of capacitive touch panel techniques are developed. As shown in FIG. 1A, a capacitive type touch panel 10 comprises a transparent substrate 11, a plurality of bridging lines 12, an insulation layer 13 and a transparent conductive layer 14. The transparent conductive layer 14 is overlaid on the top surface of the transparent substrate 11, and comprises a plurality of first electrodes 141, a plurality of second electrodes 142 and a plurality of connection lines 143. The plurality of first electrodes 141 and the plurality of second electrodes 142 are arranged in a staggered manner, and each of the first electrodes 141 is surrounded by four second electrodes 142. Each of the plurality of connection lines 143 respectively connects the adjacent second electrodes 142. The insulation layer 13 further comprises a plurality of insulation areas 131, and the plurality of insulation areas 131 are respectively overlaid on the plurality of connection lines 143. The plurality of bridging lines 12 are respectively disposed on the plurality of insulating areas 131 and respectively connect the adjacent first electrodes 141.

The prior art first electrodes 141 and second electrodes 142 are square or diamond transparent electrodes. However, the transparent electrodes absorb some amount of light, which causes the touch panel 10 to absorb too is much light emitted from a lower display apparatus (not shown). Therefore, the touch screen appears darker.

Thus, there is a need to provide a touch panel that overcomes the above drawbacks of the conventional touch panels, and still has good electrical characteristics.

### SUMMARY OF THE INVENTION

An aspect of the present invention is to provide a capacitive type touch panel with high transmittance. The pattern of the sensing electrode of the capacitive type touch panel is a wiring pattern rather than a conventional square or diamond pattern, and thus the light absorbed by the sensing electrode can be reduced while maintaining the same surrounding area or effective sensing area of the wiring pattern.

Another aspect of the present invention is to provide a capacitive type touch panel with lower resistance. A plurality of auxiliary metal lines are disposed on the connecting lines which connect electrode units, and on the wiring pattern of the sensing electrode. Since the auxiliary metal lines can support large currents, the connecting lines or wiring electrodes having higher resistance can be protected, and the overall impedance of the sensing conductive layer can be reduced.

In view of above, the present invention discloses a capacitive type touch panel which comprises a transparent substrate, a transparent conductive layer, an insulating layer, and a plurality of first leads. The transparent conductive layer is overlaid on a surface of the transparent substrate and comprises a plurality of first electrodes, a plurality of second electrodes and a plurality of connecting lines. The plurality of first electrodes and the plurality of second electrodes are arranged in a staggered manner, and the plurality of connecting lines respectively connect two adjacent second electrodes. The insulating layer comprises a plurality of insulating areas, wherein the plurality of insulating areas are respectively overlaid on the plurality of connecting lines. The plurality of first leads are is respectively disposed on the plurality of insulating areas and respectively connect two adjacent first electrodes. Each of the first electrodes and second electrodes has a pattern which is formed by transparent electrode leads.

The capacitive type touch panel further comprises a plurality of second leads respectively disposed on each of the transparent electrode leads.

The present invention further discloses a capacitive type touch panel which comprises a first transparent substrate, a first transparent conductive layer, a second transparent substrate, and a second transparent conductive layer. The first transparent conductive layer is overlaid on a surface of the first transparent substrate and comprises a plurality of first electrodes and a plurality of first connecting lines, wherein the plurality of first connecting lines respectively connect the adjacent first electrodes. The second transparent substrate is disposed on the first transparent conductive layer. The second transparent conductive layer is disposed on the second transparent substrate and comprises a plurality of second electrodes and a plurality of second connecting lines, wherein the plurality of second connecting lines respectively connect the adjacent second electrodes. Each of the first electrodes and second electrodes has a wiring pattern which is formed by transparent electrode leads.

### BRIEF DESCRIPTION OF THE DRAWINGS

The invention will be described according to the appended drawings in which:

FIG. 1 is a diagram of a conventional touch panel;

FIG. 2A is a diagram of a capacitive type touch panel in accordance with one embodiment of the present invention;

FIG. 2B is an enlarged diagram of part B shown in FIG. 2A;

FIG. 3A is a schematic diagram of a capacitive type touch panel in accordance with one embodiment of the present invention;

FIG. 3B is an enlarged diagram of part A shown in FIG. 3A; and FIGS. 4A to 4D are diagrams of various patterns of the first electrode.

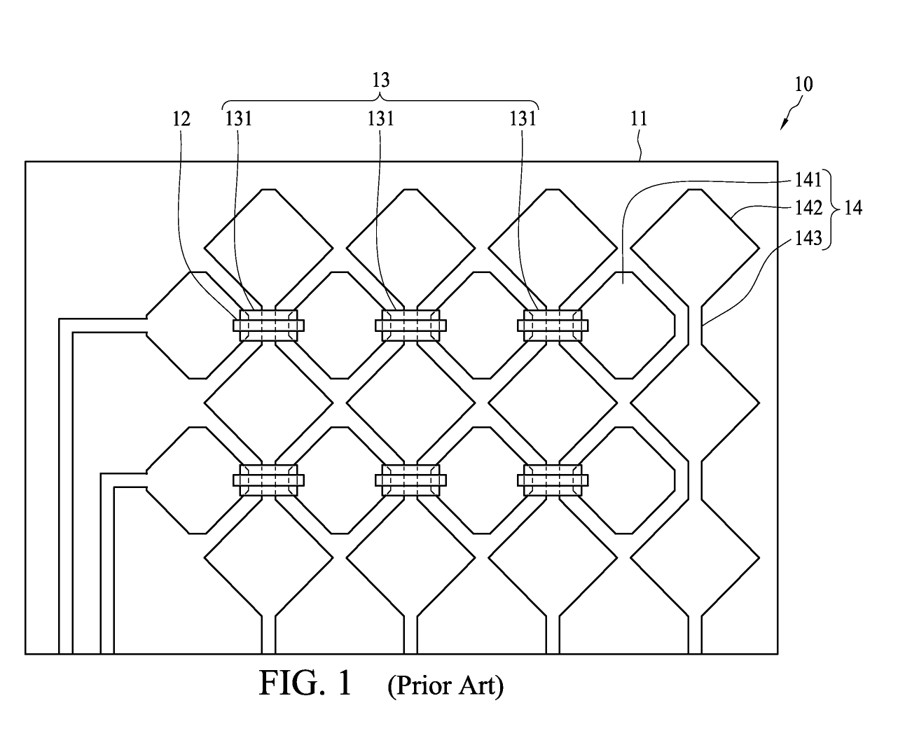

### PREFERRED EMBODIMENT OF THE PRESENT INVENTION

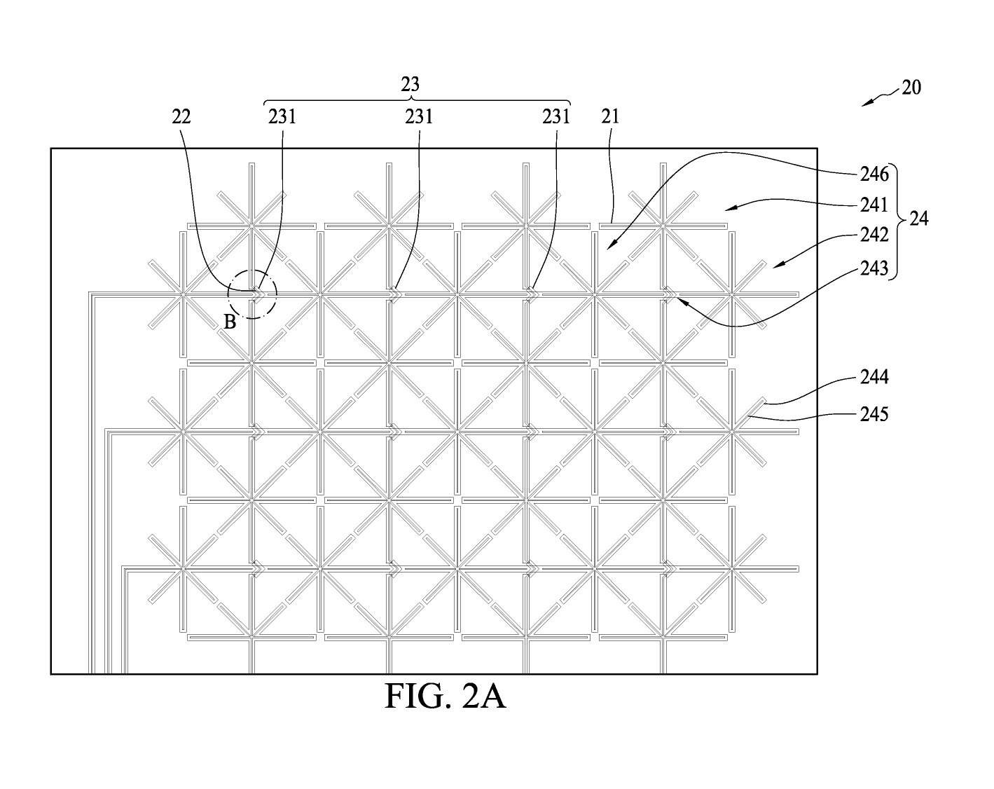

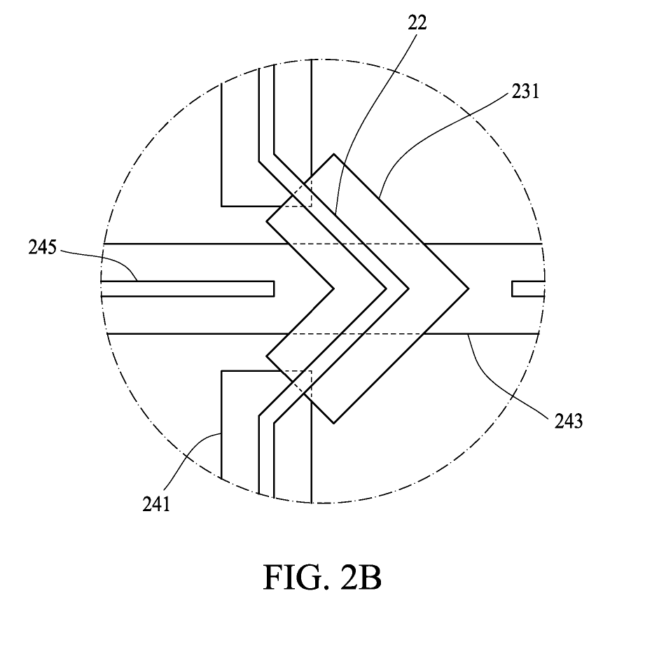

FIG. 2A is a diagram of a capacitive type touch panel in accordance with one embodiment of the present invention. As shown in FIG. 2A, a capacitive type touch panel 20 comprises a transparent substrate 21, a transparent conductive layer 24, an insulating layer 23, and a plurality of first leads 22. The transparent conductive layer 24 is overlaid on a surface of the transparent substrate 21 and comprises a plurality of first electrodes 241, a plurality of second electrodes 242 and a plurality of connecting lines 243. Each of the first electrodes 241 and second electrodes 242 has a radiating wiring pattern which is formed by transparent electrode leads 244. The plurality of first electrodes 241 and the plurality of second electrodes 242 are arranged in a staggered manner, and the plurality of connecting lines 243 respectively connect the adjacent second electrodes 242. The insulating layer 23 further comprises a plurality of insulating areas 231, each of which is overlaid on one of the connecting lines 243. The insulating areas 231 can be overlaid on the connecting lines 243 with an arbitrary shape, and are not limited to a V-shape as shown in FIG. 2A. The plurality of first leads 22 are respectively disposed on the plurality of insulating areas 231, and respectively connect two adjacent first electrodes 241. The first leads 22 are formed by a photolithography process.

Because the transparent connecting lines 243 and the transparent electrode leads 244 have higher resistances, a plurality of second leads 245 can be respectively disposed on the connecting lines 243 and the electrode leads 244. In this manner, the transparent connecting lines 243 and the transparent electrode leads 244 having higher resistances can be protected, and the overall impedance of the transparent conductive layer 24 can be reduced. The second leads 245 and the first leads 22 are preferably formed is by the same photolithography process, or by another photolithography process. To avoid oxidation or scratching on the second leads 245 and first leads 22, a passivation layer (not shown) can be overlaid on the second leads 245 and/or first leads 22.

The material of the transparent conductive layer 24 is an indium-tin oxide (ITO), aluminum-zinc oxide (AZO) or indium-zinc oxide (IZO). The photolithography processes include sputter, coating, exposure, soft baking, hard baking, development, baking and other processes. The material of the transparent substrate 21 is glass or a transparent polymer plate such as polycarbonate (PC) and polyvinyl chloride (PVC). The material of the insulating layer 23 is a transparent polymer such as a photoresist material. The material of the first leads 22 and second leads 245 is polymer conductive material, conductive oxide or metal.

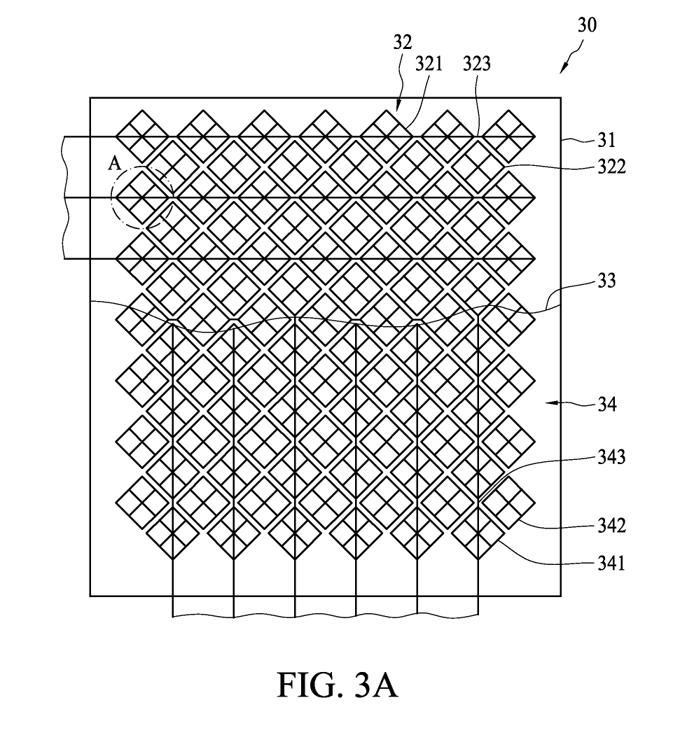

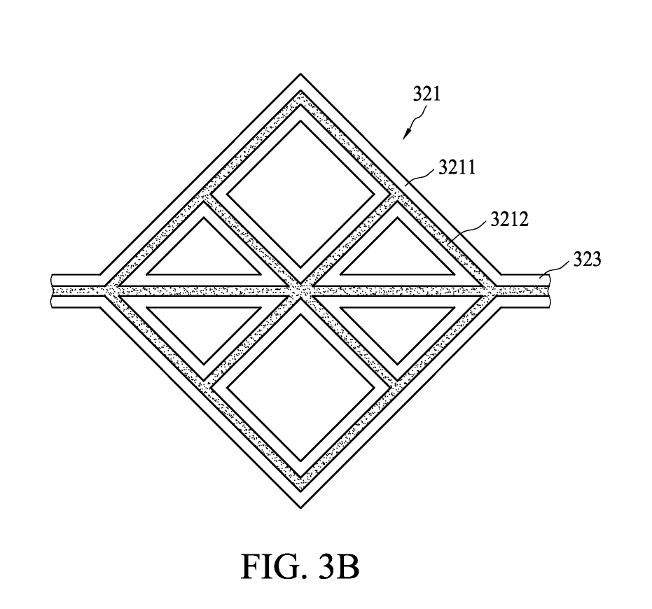

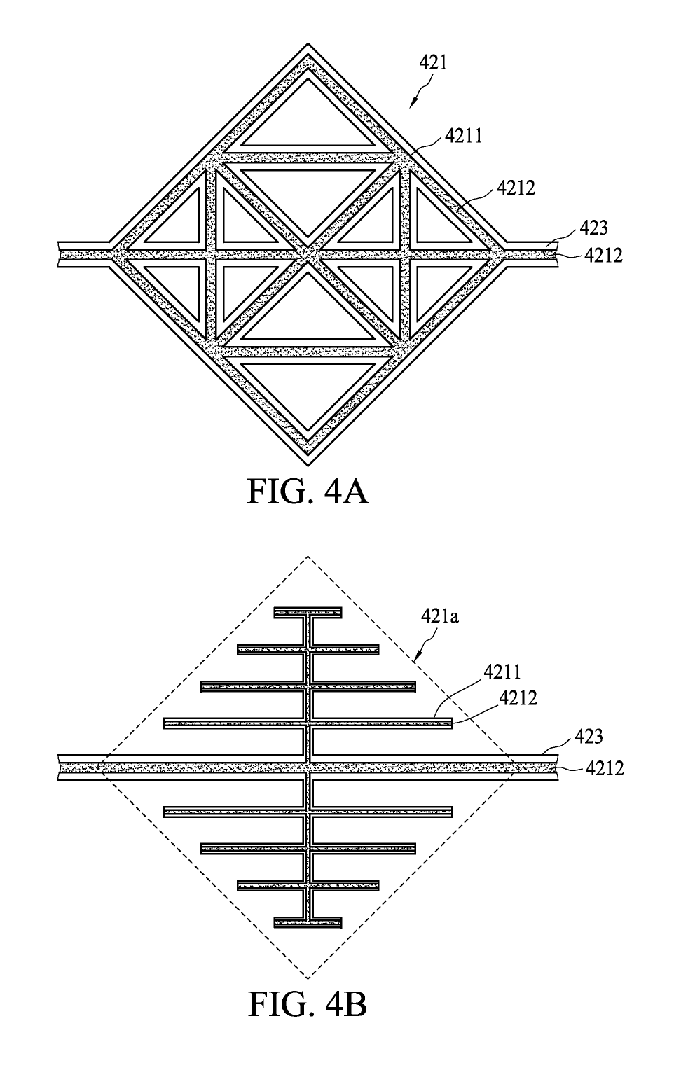

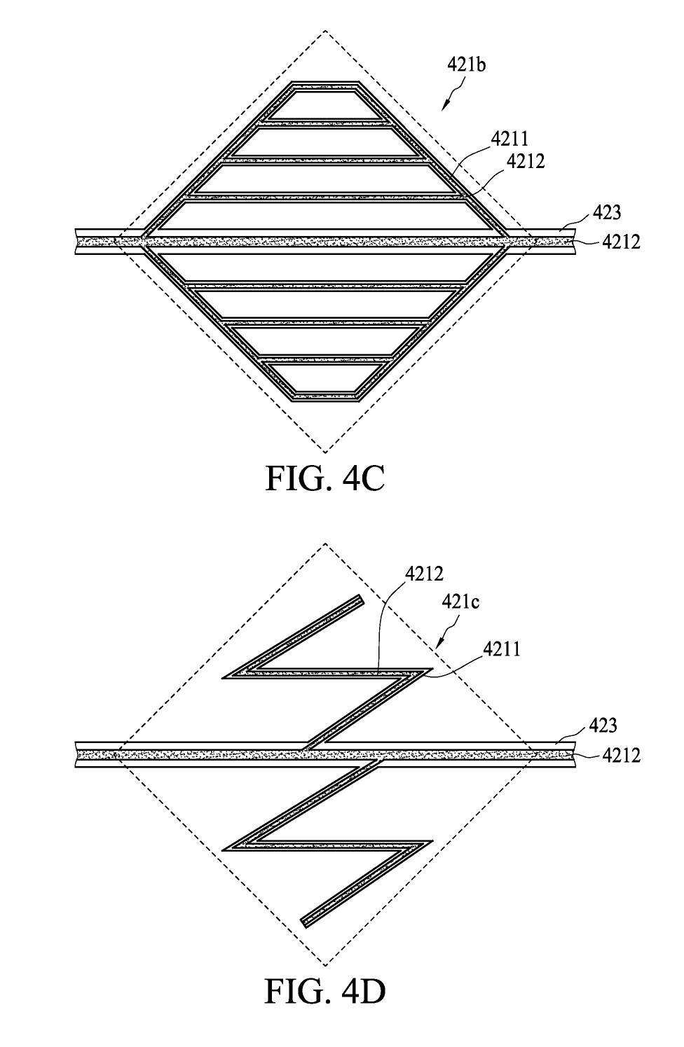

FIG. 3A is a diagram of a capacitive type touch panel in accordance with one embodiment of the present invention. As shown in FIG. 3A, a capacitive type touch panel 30 comprises a first transparent substrate 31, a transparent conductive layer 32, a second transparent substrate 33, and a second transparent conductive layer 34. The first transparent conductive layer 32 is overlaid on a surface of the transparent substrate 31, and comprises a plurality of first electrodes 321, a plurality of first dummy electrodes 322 and a plurality of first connecting lines 323. The plurality of first electrodes 321 and the plurality of first dummy electrodes 322 are arranged in a staggered manner, and the plurality of first connecting lines 323 respectively connect the adjacent first electrodes 321. The second transparent substrate 33 is disposed on the first transparent conductive layer 32. The second transparent conductive layer 34 is overlaid on the second transparent substrate 33, and comprises a plurality of second electrodes 341, a plurality of second dummy electrodes 342 and a plurality of second connecting lines 343. The plurality of second electrodes 341 and the plurality of second dummy electrodes 342 are arranged in a staggered manner and the plurality of second connecting lines 343 respectively is connect the adjacent second electrodes 341. Each of the first electrodes 321, the first dummy electrodes 322, the second electrodes 341, and the second dummy electrodes 342 has a pattern which is formed by transparent electrode leads.

The first transparent conductive layer 32 can be formed on the first transparent substrate 31 first. Also, the second transparent conductive layer 34 can be formed on the second transparent substrate 33 first, and then the first transparent substrate 31 having circuits can be combined, for example by adhesion, with the second transparent substrate 33 having circuits.

FIG. 3B is an enlarged diagram of part A shown in FIG. 3A. The first electrode 321 has a closed mesh pattern which is formed by transparent electrode leads 3211. Because the transparent electrode leads 3211 and the first connecting lines 323 have higher resistances, a plurality of first leads 3212 can be respectively disposed on the transparent electrode leads 3211 and the first connecting lines 323. In addition, the first dummy electrodes 322 are electrodes for balancing the brightness difference on the touch panel rather than sensing the touch on the touch panel. Therefore, the first dummy electrodes 322 can be implemented with stacked leads or neglected. Similarly, the second electrodes 341 or the second dummy electrodes 342 can be implemented as a stacked structure with transparent electrode leads and leads as shown in FIG. 3B.

FIGS. 4A and 4B are diagrams of various patterns of the first electrode.

The first electrode 421 in FIG. 4A has a plurality of transparent electrode leads 4211 and first leads 4212, and thus the mesh pattern is more compact. In addition, first connecting lines 423 are also disposed on the first leads 4212.

Referring to FIG. 4B, the transparent electrode leads 4211 and the first leads 4212 are symmetrical about the middle and extend toward an outside edge of a first electrode 421a. The transparent electrode leads 4211 and the first leads 4212 have a fishbone-like pattern. The surrounding area or effective sensing area (indicated by a dashed line) of such open pattern of is the first electrode 421a can be kept unchanged.

FIG. 4C is a pattern of the first electrode 421b, wherein the pattern is a closed groove pattern. The surrounding area or effective sensing area of the pattern is approximately square. FIG. 4D is a pattern of the first electrode 421c, wherein the pattern is another open pattern. The transparent electrode leads 4211 and the first leads 4212 are symmetrical about the middle and extend toward an outside edge of a first electrode 421a in a meandering or zig-zag manner.

The first electrodes 321, the first dummy electrodes 322, the second electrodes 341, and the second dummy electrodes 342 of the present invention have a pattern formed by transparent electrode leads. The pattern can be, but not limited to, a closed wiring, an open wiring, a meandering or zig-zag straight line, a meandering or zig-zag curved line, a mesh wiring, and a groove wiring.

The above descriptions of the present invention are intended to be illustrative only. Numerous alternative methods may be devised by persons skilled in the art without departing from the scope of the following claims.

What is claimed is:

1. A capacitive type touch panel, comprising:
a transparent substrate;
a transparent conductive layer overlaid on a surface of the transparent substrate and comprising a plurality of first electrodes, a plurality of second electrodes, and a plurality of connecting lines, wherein the plurality of first electrodes and the plurality of second electrodes are arranged in a staggered manner, and the plurality of connecting lines respectively connect two adjacent second electrodes;
an insulating layer comprising a plurality of insulating areas, wherein the plurality of insulating areas are respectively overlaid on the plurality of connecting lines; and
a plurality of first leads respectively disposed on the plurality of insulating areas and respectively connecting two adjacent first electrodes;
wherein each of the first electrodes and second electrodes has a pattern which is formed by transparent electrode leads.

2. The capacitive type touch panel of claim 1, further comprising a plurality of second leads respectively disposed on each of the transparent electrode leads.

3. The capacitive type touch panel of claim 1, wherein each of the first electrodes and second electrodes has a closed wiring pattern or an open wiring pattern which is formed by the transparent electrode leads.

4. The capacitive type touch panel of claim 3, wherein the closed wiring pattern is a mesh wiring pattern or a groove wiring pattern.

5. The capacitive type touch panel of claim 3, wherein the open wiring pattern is a radiating wiring pattern or a meandering wiring pattern.

6. The capacitive type touch panel of claim 1, further comprising a passivation layer overlaid on the first leads and/or on the second leads.

7. The capacitive type touch panel of claim 1, wherein the material of the first leads and second leads is polymer conductive material, conductive oxide or metal.

8. The capacitive type touch panel of claim 1, wherein the material of the transparent conductive layer is conductive oxide.

9. The capacitive type touch panel of claim 1, wherein the material of the transparent substrate is glass or a transparent polymer plate.

10. A capacitive type touch panel, comprising:
a first transparent substrate;
a first transparent conductive layer overlaid on a surface of the first transparent substrate and comprising a plurality of first electrodes and a plurality of first connecting lines, wherein the plurality of first connecting lines respectively connect the adjacent first electrodes;
is a second transparent substrate disposed on the first transparent conductive layer; and
a second transparent conductive layer disposed on the second transparent substrate and comprising a plurality of second electrodes and a plurality of second connecting lines, wherein the plurality of second connecting lines respectively connect the adjacent second electrodes;
wherein each of the first electrodes and second electrodes has a wiring pattern which is formed by transparent electrode leads.

11. The capacitive type touch panel of claim 10, wherein the first transparent conductive layer comprises a plurality of first dummy electrodes formed by transparent electrode leads, and the plurality of first electrodes and the plurality of first dummy electrodes are arranged in a staggered manner.

12. The capacitive type touch panel of claim 10, wherein the second transparent conductive layer comprises a plurality of second dummy electrodes formed by transparent electrode leads, and the plurality of second electrodes and the plurality of second dummy electrodes are arranged in a staggered manner.

13. The capacitive type touch panel of claim 10, further comprising a plurality of first leads respectively disposed on the transparent electrode leads of each of the plurality of first electrodes.

14. The capacitive type touch panel of claim 10, further comprising a plurality of second leads respectively disposed on the transparent electrode leads of each of the plurality of second electrodes.

15. The capacitive type touch panel of claim 10, further comprising a passivation layer overlaid on the first leads and/or second leads.

16. The capacitive type touch panel of claim 10, wherein the is wiring pattern is a mesh wiring pattern or a groove wiring pattern.

17. The capacitive type touch panel of claim 10, wherein the wiring pattern is a radiating wiring pattern or a meandering wiring pattern.

18. The capacitive type touch panel of claim 10, wherein the material of the first leads and second leads is polymer conductive material, conductive oxide or metal.

19. The capacitive type touch panel of claim 10, wherein the material of the first or second transparent conductive layer is conductive oxide.

20. The capacitive type touch panel of claim 10, wherein the material of the first or second transparent substrate is glass or a transparent polymer plate.
